(19) United States
(12) Patent Application Publication
(10) Pub. No.: US 2009/0265160 A1
(43) Pub. Date: Oct. 22, 2009

(54) COMPARING TEXT BASED DOCUMENTS

(75) Inventors: Robert Francis Williams, Bull Creek (AU); Heinz Dreher, Mahogany Creek (AU)

Correspondence Address: HESLIN ROTHENBERG FARLEY & MESITI PC, 5 COLUMBIA CIRCLE, ALBANY, NY, 12203, US

(73) Assignee: CURTIN UNIVERSITY OF TECHNOLOGY, Bentley, WA (AU)

(21) Appl. No.: 11/914,378

(22) PCT Filed: May 12, 2006
(86) PCT No.: PCT/AU06/00630

§ 371 Date: Jul. 9, 2008

(30) Foreign Application Priority Data
May 13, 2005 (AU) 2005902424
Jun. 10, 2005 (AU) 2005903032

(51) Int. Cl. G06F 17/27

(52) U.S. Cl. 704/9; 382/218

(57) ABSTRACT

Text based documents are compared by lexically normalising each word of the text of a first document (104) to form a first normalised representation. A vector representation of the first document is built (206) from the first normalised representation. Each word of the text of a second document (110) is lexically normalised to form a second normalised representation. A vector representation of the second document is built (204) from the second normalised representation. The alignment of the vector representations is compared (210) to produce a score (218) of the similarity of the second document to the first document.

### FIELD OF THE INVENTION

The present invention relates to comparing text based documents using an automated process to obtain an indication of the similarity of the documents. The present invention has application in many areas including but not limited to document searching and automated essay grading.

### BACKGROUND

In simple terms internet search engines scan web pages (which are text based documents) for nominated words and return result of web pages that match the nominated words. Internet search engines are not known for finding documents that are based on similar concepts but which do not use the nominated words.

Automated essay grading is more complex. Here the aim is to grade an essay (text based document) on its content compared to an expected answer not on a particular set of words.

### SUMMARY OF THE PRESENT INVENTION

According to a first aspect of the present invention there is provided a method of comparing text based documents comprising:
lexically normalising each word of the text of a first document to form a first normalised representation;
building a vector representation of the first document from the first normalised representation;
lexically normalising each word of the text of a second document to form a second normalised representation;
building a vector representation of the second document from the second normalised representation;
comparing the alignment of the vector representations to produce a score of the similarity of the second document to the first document.

Preferably the lexical normalisation converts each word in the document into a representation of a root concept as defined in a thesaurus. Each word is used to look up the root concept of the word in the thesaurus. Preferably each root word is allocated a numerical value. Thus the normalisation process in some embodiments produces a numeric representation of the document. Each normalised root concept forms a dimension of the vector representation. Each root concept is counted. The count of each normalised root concept forms the length of the vector in the respective dimension of the vector representation.

Preferably the comparison of the alignment of the vector representations produces the score by determining the cosine of an angle (theta) between the vectors.

Typically the cos(theta) is calculated from the dot product of the vectors and the length of the vectors.

In some embodiments the number of root concepts in the document is counted. In an embodiment each root concept of non-zero count provides a contribution to a count of concepts in each document. Certain root concepts may be excluded from the count of concepts. Preferably the count of concepts of the second document is compared to the count of concepts of the first document to produce a contribution to the score of the similarity of the second document to the first document. Typically the contribution of each root concept of non-zero count is one. Preferably the comparison is a ratio.

In a preferred embodiment the first document is a model answer essay, the second document is an essay to be marked and the score is a mark for the second essay.

According to a second aspect of the present invention there is provided a system for comparing text based documents comprising:
means for lexically normalising each word of the text of a first document to form a first normalised representation;
means for building a vector representation of the first document from the first normalised representation;
means for lexically normalising each word of the text of a second document to form a second normalised representation;
means for building a vector representation of the second document from the second normalised representation; means for lexically normalising the text of a first document;
means for comparing the alignment of the vector representations to produce a score of the similarity of the second document to the first document.

According to a third aspect of the present invention there is provided a method of comparing text based documents comprising:
partitioning words of a first document into noun phrases and verb clauses;
partitioning words of a second document into noun phrases and verb clauses;
comparing the partitioning of the first document to the second document to produce a score of the similarity of the second document to the first document.

In one embodiment each word in the document is lexically normalised into root concepts.

Preferably the comparison of the partitioning of the documents is conducted by determining a ratio of the number of one or more types of noun phrase components in the second document to the number of corresponding types of noun phrase components in the first document and a ratio of the number of one or more types of verb clause components in the second document to the number of corresponding types of verb clause components in the first document, wherein the ratios contribute the score.

Preferably the types of noun phrase components are: noun phrase nouns, noun phrase adjectives, noun phrase prepositions and noun phrase conjunctions. Preferably the types of clause components are: verb clause verbs, verb clause adverbs, verb clause auxiliaries, verb clause prepositions and verb clause conjunctions.

In a preferred embodiment the first document is a model answer essay, the second document is an essay to be marked and the score is a mark for the second essay.

According to a fourth aspect of the present invention there is provided a system for comparing text based documents comprising:
means for partitioning words of a first document into noun phrases and verb clauses;
means for partitioning words of a second document into noun phrases and verb clauses;
means for comparing the partitioning of the first document to the second document to produce a score of the similarity of the second document to the first document.

According to a fifth aspect of the present invention there is provided a method of comparing text based documents comprising:
lexically normalising each word of the text of a first document to form a first normalised representation;
determining the number of root concepts in the first document from the first normalised representation;
lexically normalising each word of the text of a second document to form a second normalised representation;
determining the number of root concepts in the second document from the second normalised representation;
comparing the number of root concepts in the first document to the number of root concepts in the second document to produce a score of the similarity of the second document to the first document.

According to a sixth aspect of the present invention there is provided a system for comparing text based documents comprising:
means for lexically normalising each word of the text of a first document to form a first normalised representation;
means for determining the number of root concepts in the first document from the first normalised representation;
means for lexically normalising each word of the text of a second document to form a second normalised representation;
means for determining the number of root concepts in the second document from the second normalised representation;
means for comparing the number of root concepts in the first document to the number of root concepts in the second document to produce a score of the similarity of the second document to the first document.

According to a seventh aspect of the present invention there is provided a method of grading a text based essay document comprising:
providing a model answer;
providing a plurality of hand marked essays;
providing a plurality of essays to be graded;
providing an equation for grading essays, wherein the equation has a plurality of measures with each measure having a coefficient, the equation producing a score of the essay being calculated by summing each measure as modified by its respective coefficient, each measure being determined by comparing each essay to be graded with the model essay;
determining the coefficients from the hand marked essays;
applying the equation to each essay to be graded to produce a score for each essay.

Preferably determining the coefficients from the hand marked essays is performed by linear regression.

Preferably the measures include the scores produced by the methods of comparing text based documents described above.

According to an eighth aspect of the present invention there is provided a system for grading a text based essay document comprising:
means for determining coefficients in an equation from a plurality of hand marked essays, wherein the equation is for grading an essay to be marked, the equation comprising a plurality of measures with each measure having one of the coefficients, the equation producing a score for the essay which is calculated by summing each measure as modified by its respective coefficient,
   means for determining each measure by comparing each essay to be graded with the model essay;
means for applying the equation to each essay to be graded to produce a score for each essay from the determined coefficients and determined measures.

According to a ninth aspect of the present invention there is provided a method of providing visual feedback on an essay grading comprising:
displaying a count of each root concept in the graded essay and a count of each root concepts expected in the answer.

Preferably each root concept corresponds to a root meaning of a word as defined by a thesaurus. In some embodiments the count of each root concept is determined by lexically normalising each word in the graded essay to produce a representation of the root meanings in the graded essay and counting the occurrences of each root meaning. The count of root concepts in the answer is counted in the same way from a model answer.

Preferably the display is graphical. More preferably the display is a bar graph for each root concept.

In an embodiment the method further comprises selecting a concept in the essay and displaying words belonging to that concept in the essay. Preferably words related to other concepts in the answer are also displayed. Preferably this display is by highlighting.

In another embodiment the method further comprises selecting a concept in expected essay and displaying words belonging to that concept in the essay. Preferably words related to other concepts in the answer are also displayed. Preferably this display is by highlighting.

Preferably the method further comprises displaying synonyms to selected root concept.

According to a tenth aspect of the present invention there is provided a system for providing visual feedback on an essay grading comprising:
means for displaying a count of each root concept in the graded essay and a count of each root concepts expected in the answer.

According to an eleventh aspect of the present invention there is provided a method of numerically representing a document comprising:
lexically normalising each word of the document;
partitioning the normalised words of the document into parts, which each part designates as one of a noun phrase or a verb clause.

Preferably a plurality of words are used to determine whether each part is a noun phase or a verb clause. In an embodiment the first three words of each part are used to determine whether the part is a noun phrase or a verb clause. In some embodiments each word in a part is allocated to a column-wise slot of a noun phrase or verb clause table.

Each slot of the table is allocated to a grammatical type of word.

Words are allocated sequentially to slots in the appropriate table if they are of the grammatical type of the next slot. In the event that the next word does not belong in the next slot, the slot is left blank and the sequential allocation of slots moves on one position.

In the event that the next word does not belong to the table type of the current part then this indicates an end to the current part.

In some embodiments the tables have a plurality of rows such that when the next word does not fit into the rest of the row following placement of the current word in the current part, but the word does not indicate an end to the current part then it is placed in the next row of the table.

According to a twelfth aspect of the present invention there is provided a system for numerically representing a document comprising:
means for lexically normalising each word of the document;
means for partitioning the normalised words of the document into parts, which each part designates as one of a noun phrase or a verb clause.

According to a thirteenth aspect of the present invention there is provided a computer program configured to control a computer to perform any one of the above defined methods.

According to a fourteenth aspect of the present invention there is provided a computer program configured to control a computer to operate as any one of the above defined systems.

According to an fifteenth aspect of the present invention there is provided a computer readable storage medium comprising a computer program as defined above.

### SUMMARY OF DIAGRAMS

In order to provide a better understanding of the present invention preferred embodiments will now be described in greater detail, by way of example only, with reference to the accompanying drawings, in which:

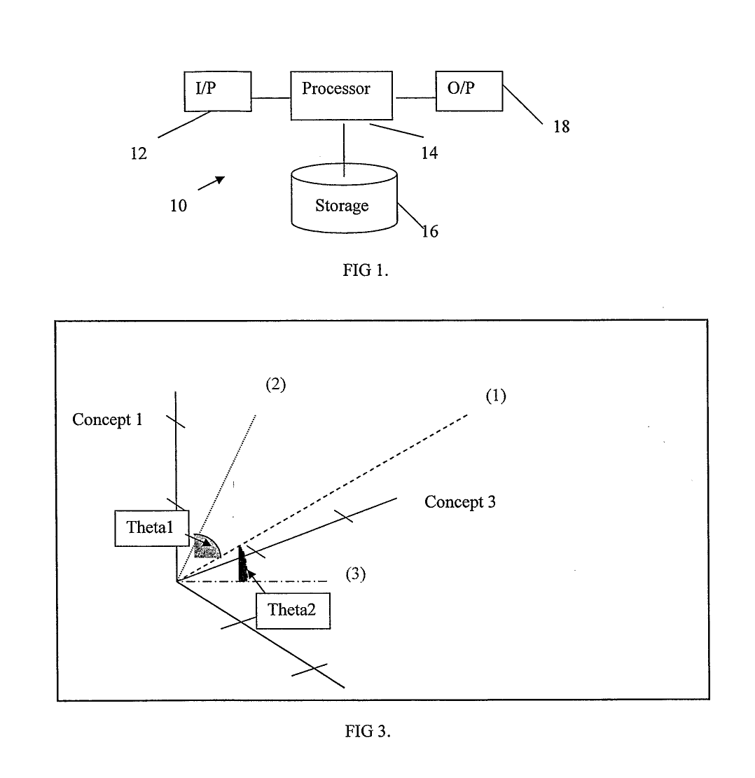

FIG. 1 is a schematic representation of a preferred embodiment of an apparatus for comparing text based documents according to an embodiment of the present invention;

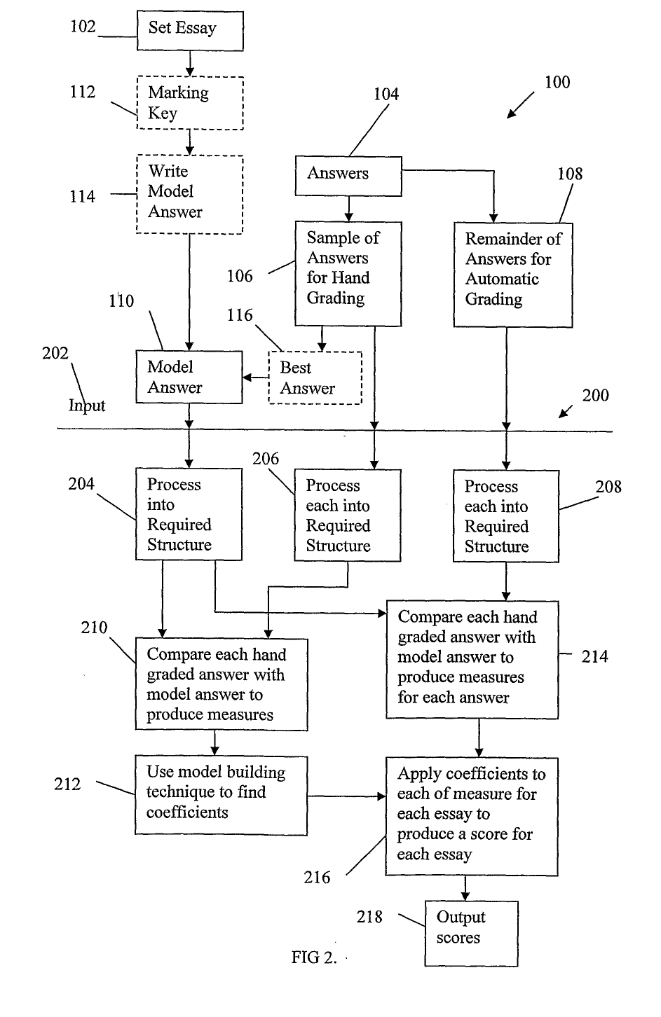

FIG. 2 is a schematic flowchart of a method of comparing text based documents according to an embodiment of the present invention, in which the text based documents are a model answer essay and essays for grading;

FIG. 3 is a graphical display of a vector representation of 3 documents;

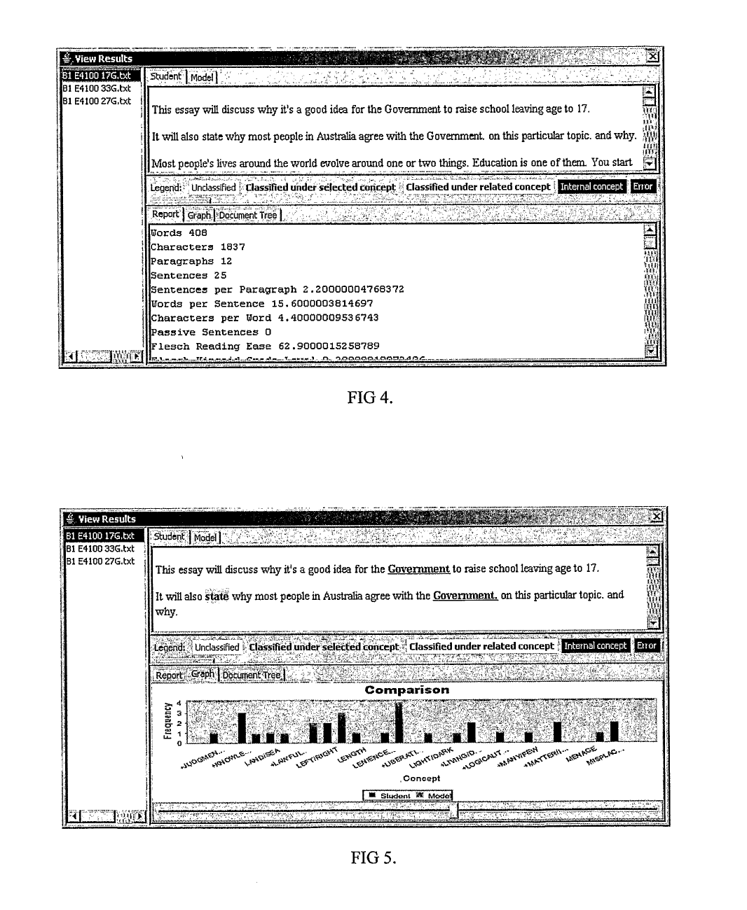

FIG. 4 is a screen shot of a window produced by a computer program of an embodiment of the present invention in which an essay is graded according to a method of an embodiment of the present invention;

FIG. 5 is a screen shot of a window produced by the computer program in which concepts of the graded essay are compared to concepts of a model answer;

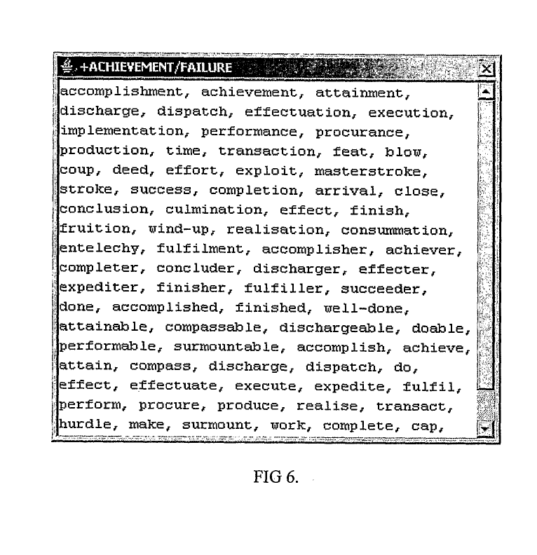

FIG. 6 is a window showing a list of synonyms;

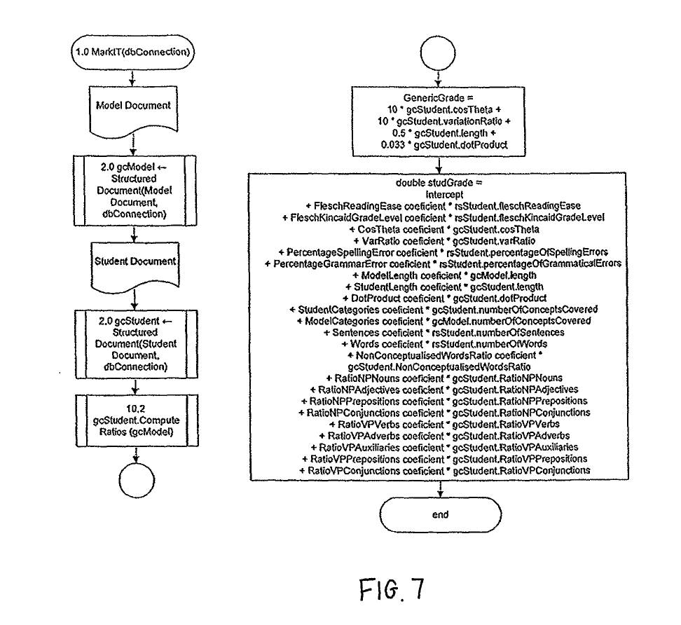

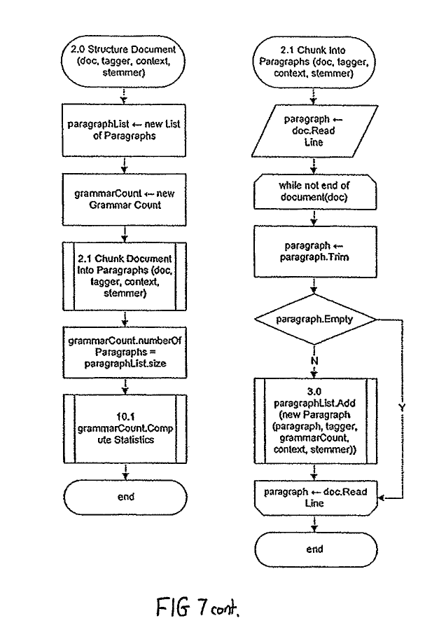

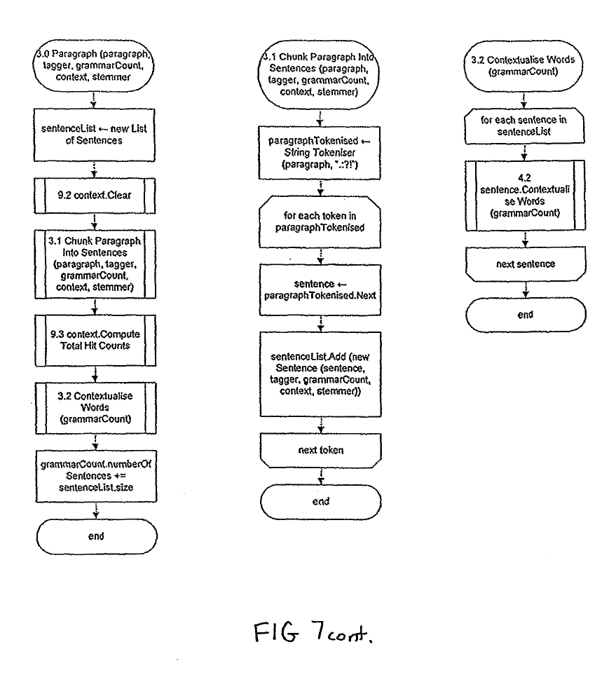

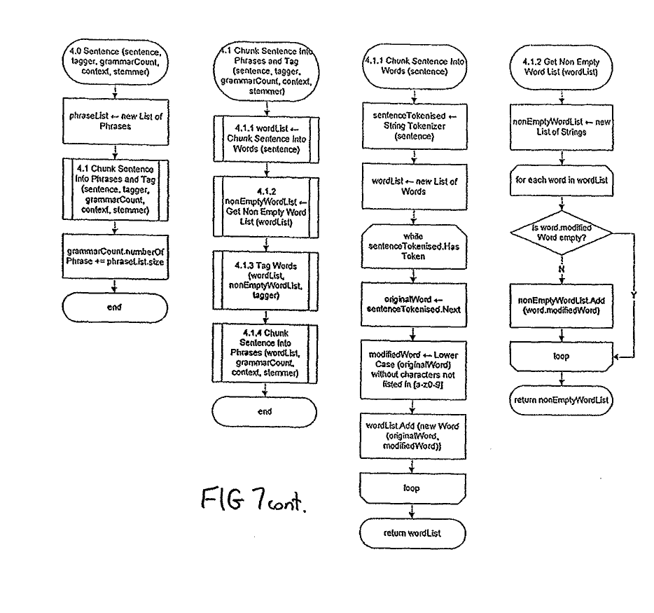

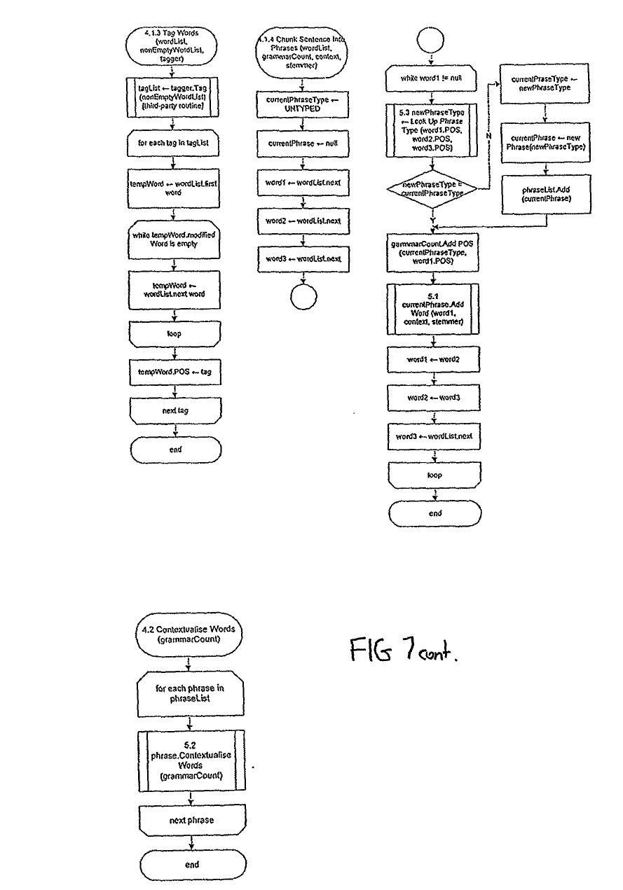

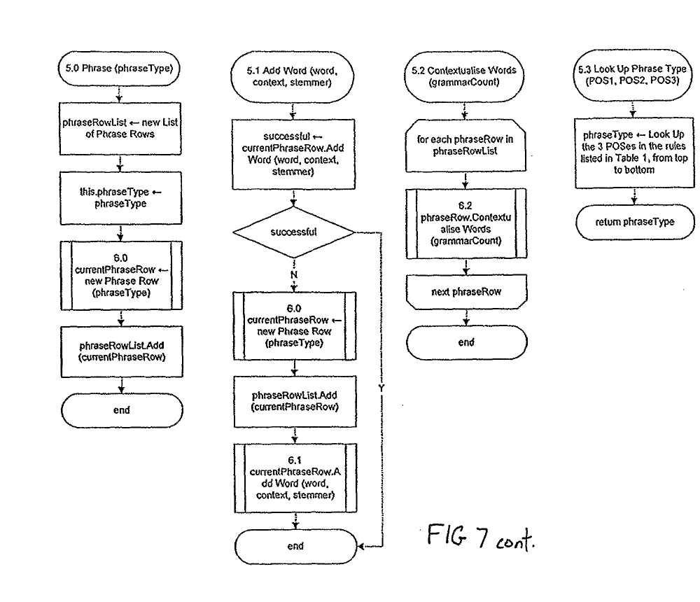

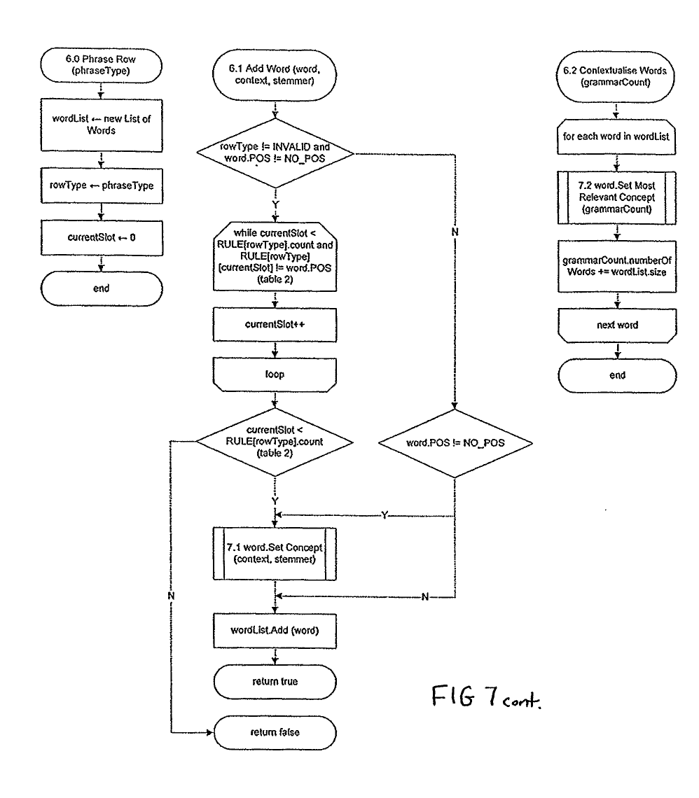

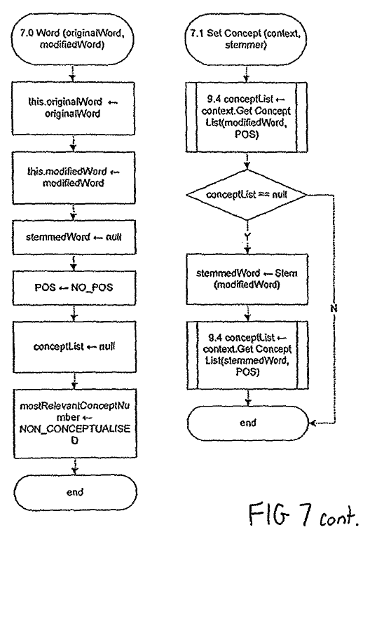

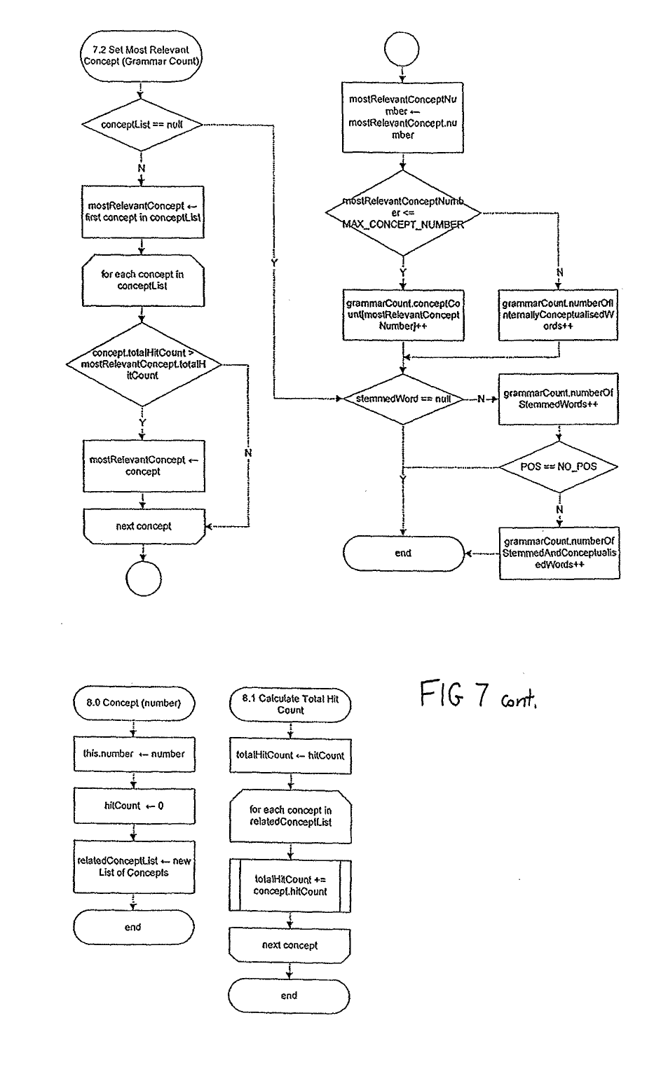

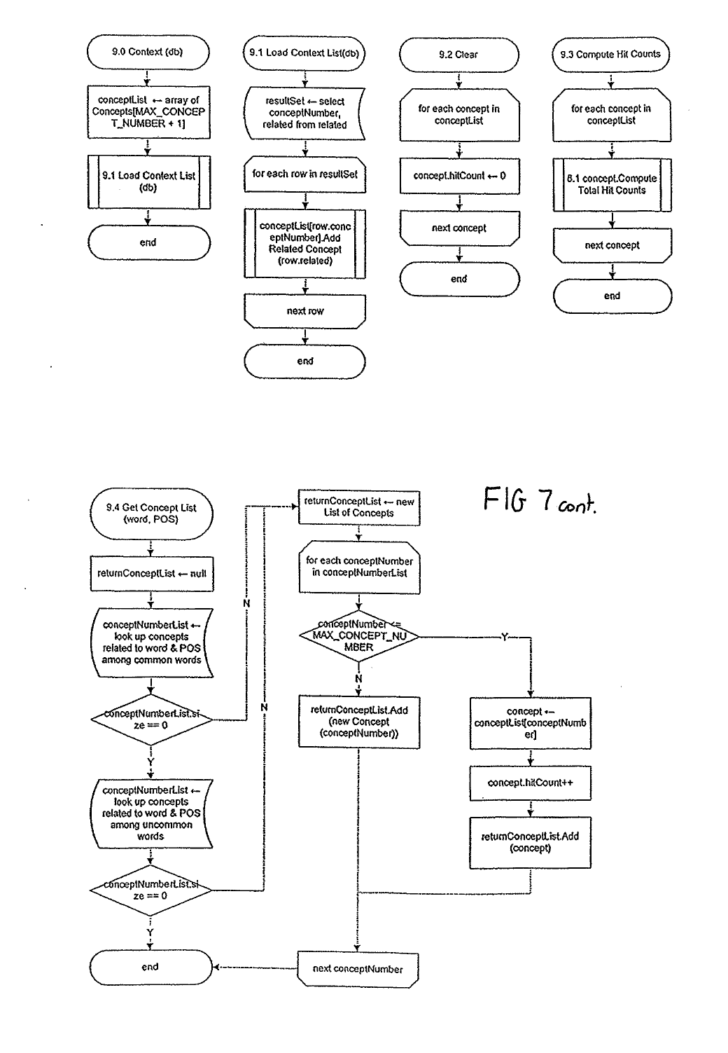

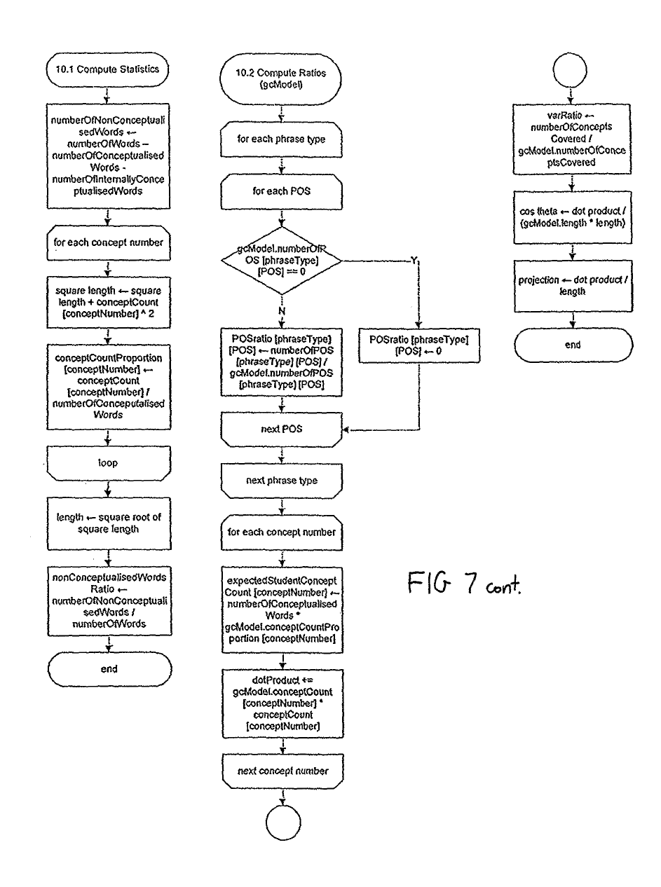

FIG. 7 is a set of flow charts of some embodiments of the present invention; and

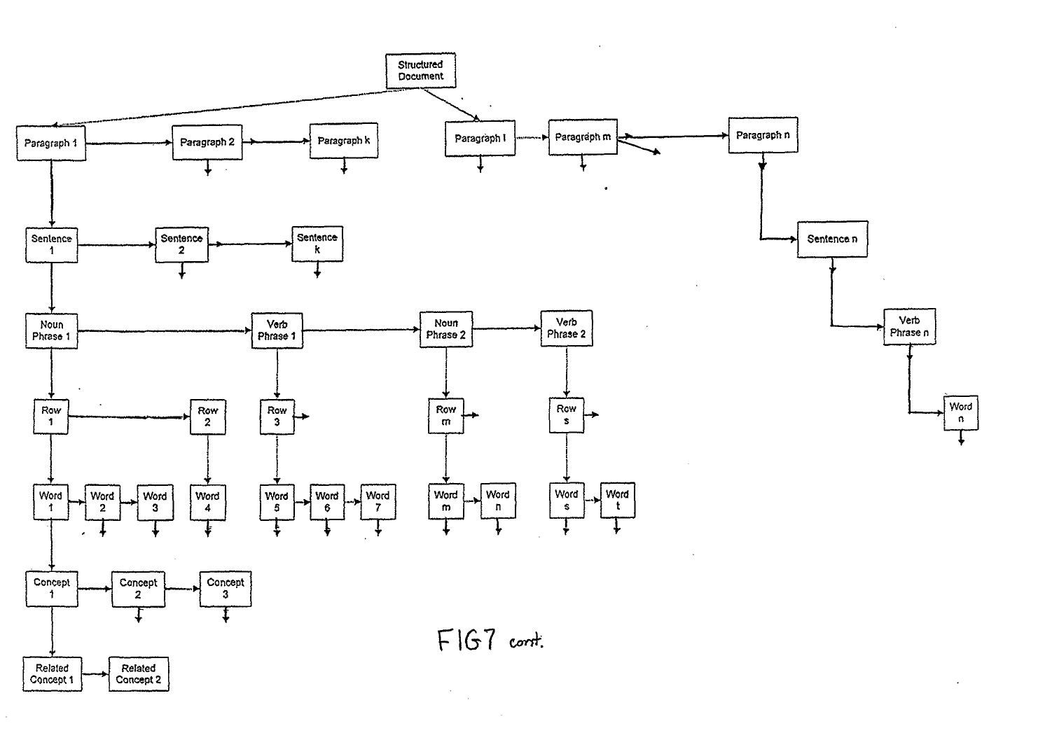

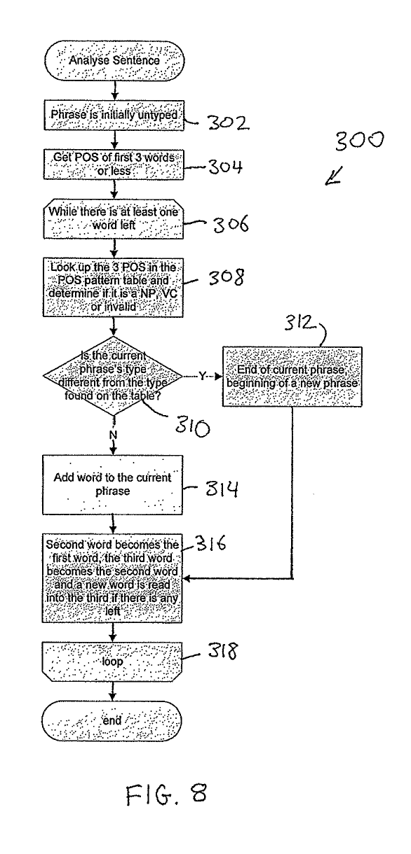

FIG. 8 is a flow chart of an embodiment of the present invention.

### DETAILED DESCRIPTION OF PREFERRED EMBODIMENT OF THE PRESENT INVENTION

Referring to FIG. 1 there is a system 10 for comparing text based documents, typically in the form of a computer having a processor and memory loaded with suitable software to control the computer to operate as the system for comparing text based documents 10. The system 10 includes an input 12 for receiving input from a user and for receiving electronic text based documents containing at least one word; a processor 14 for performing calculations to compare text based documents; a storage means 16, such as a hard disk drive or memory, for temporarily storing the text based documents for comparison and the computer program from controlling the processor 14; and an output 18, such as a display for providing the result of the comparison.

The system 10 is operated according to the method shown in FIG. 2. Initially a set of answers is prepared according to the process 100. An essay is set at 102 outlining the topic of the essays to be marked. Answers to the essay topic are written at 104. The answers need to be electronic text documents or converted into electronic text documents.

A sample of answers is separated at 106 for hand grading by one or more markers. The sample is preferably at least 10 answers. It has been found that a rule of thumb is that roughly 5 times the number of predictors should be used as the number of documents in the sample. For the equation below as least 50 and preferably 100 documents should be in the sample. Typically a marking key 112 is devised from the essay topic 102. One or preferably more markers hand (manually) grades the sample. Where more than one person grades the same paper, which is desirable, an average grade for the hand graded sample is produced.

The remainder of the answers 104 form the answers for automatic grading 108.

A model answer 110 is required. The model answer can be written at 114 from the marking key or the best answer 116 of the sample of answers for hand grading 106 can be used as the model answer.

Each of the text based answers, that is, the model answer 110, the sample of hand graded answers 106 and the remainder of the answers for automatic grading 108 are inputted 202 into the system 10 through input 12.

The automatic essay grading technique 200 is then followed. From each of the inputs 202 of the model answer 110, sample of answers that have been hand graded 106 and remaining answers for automatic grading 108 are each processed into a required structure as will be described further below. These steps are 204, 206 and 208 respectively. The processed model answer from 204 is then compared at 210 with each processed hand graded answer from 206 to produce a set of measures, as will be defined in more detail below. The measures are essentially one or more values that compare each of the hand graded answers with the model answer using a plurality of techniques. The measures are then used to find coefficients of a scoring equation as will be described further below.

Each of the measures for each hand graded answer is compared 212 to the score provided during hand grading and a model building technique used to find the coefficients that best produce the hand graded scores from each of the measures. Typically this will be by a linear regression technique. Although it will be appreciated that other modelling techniques may be used.

Each of the essay answers requiring automatic grading from 208 are compared 214 with the model answer from 204 to produce measures for each answer. The coefficients determined at 212 are then applied to the measures for each essay at 216 to produce a score for each essay. A set of scores is then output at 218. The essay answer can then be viewed using the display technique described further below to provide feedback to the essay writer.

### Equation For Score

The following equation is used to compute an essay score:

Score=C*CosTheta+D*VarRatio+otherfactors.

The term otherfactors is intended to rate the overall merit of the essay rather than the essay's answer to the topic and takes into account things like style, readability, spelling and grammatical errors. The CosTheta and VarRatio assess the extent that the essay answered the question.

C and D are weighting variables.

A more detailed equation to calculate the essay score follows:

$$Score = Intercept + A * FleschReadingEase + B * FleschKincaidGradeLevel + C * CosTheta + D * VarRatio + E * RatioNPNouns + F * RatioNPAdjectives + G * RatioNPPrepositions + H * RatioNPConjunctions + I * RatioVPVerbs + J * RatioVPAdverbs + K * RatioVPAuxilliaries + L * RatioVPPrepositions + M * RatioVPConjunctions + N * NoParagraphs + O * NoPhrases + P * NoWords + Q * NoSentencesPerParagraph + R * NoWordsPerSentence + S * NoCharactersPerWord + T * NoSpellingErrors + U * NoGrammaticalErrors$$

where A-U are the regression coefficients computed on the corresponding variables in the essay training set.

Most of the time, many of these coefficients will be zero. Intercept is the value of the intercept calculated for the regression equation (this can be thought of as the value of the intersection with the y axis);

FleschReadingEase is the Flesch reading ease computed by Microsoft Word for the student essay (Ease);
FleschKincaidGradeLevel is the Flesch-Kincaid reading level computed by Microsoft Word for the student essay (Level);
CosTheta is computed as per the explanation further below;
VarRatio is computed as per the explanation further below;
RatioNPNouns is the ratio of nouns in noun phrases in the student essay compared to the model essay;
RatioNPAdjectives is the ratio of adjectives in noun phrases in the student essay compared to the model essay;
RatioNPPrepositions is the ratio of prepositions in noun phrases in the student essay compared to the model essay;
RatioNPConjunctions is the ratio of conjunctions in noun phrases in the student essay compared to the model essay;
RatioVPVerbs is the ratio of verbs in verb clauses in the student essay compared to the model essay;
RatioVPAdverbs is the ratio of adverbs in verb clauses in the student essay compared to the model essay;
RatioVPAuxilliaries is the ratio of auxiliaries in verb clauses in the student essay compared to the model essay;
RatioVPPrepositions is the ratio of prepositions in verb clauses in the student essay compared to the model essay;
RatioVPConjunctions is the ratio of conjunctions in verb clauses in the student essay compared to the model essay;
NoParagraphs is the number of paragraphs in the student essay;
NoPhrases is the total number of Noun Phrases and Verb Clauses in the student essay;
NoWords is the number of words in the student essay;
NoSentencesPerParagraph is the average number of sentences in all paragraphs in the student essay;
NoWordsPerSentence is the average number of words in all sentences in the student essay;
NoCharactersPerWord is the average number of characters in all words in the student essay;
NoSpellingErrors is total number of spelling errors computed by Microsoft Word in the student essay; and
NoGrammaticalErrors is computed as the number of grammatical errors computed by Microsoft Word in the student essay.

The following is alternative equation which can be used to compute an essay score:

$$Score = A * FleschReadingEase + B * FleschKincaidGradeLevel + C * CosTheta + D * VarRatio + E * \% SpellingErrors + F * \% GrammaticalErrors + G * ModelLength + H * StudentLength + I * StudentDotProduct + J * NoStudentConcepts + K * NoModelConcepts + L * NoSentences + M * NoWords + N * NonConceptualisedWordSRatio + O * RatioNPNouns + P * RatioNPAdjectives + Q * RatioNPPrepositions + R * RatioNPConjunctions + S * RatioVPVerbs + T * RatioVPAdverbs + U * RatioVPAuxilliaries + V * RatioVPPrepositions + W * RatioVPConjunctions$$

where A-W are the regression coefficients computed on the corresponding variables in the essay training set.

Most of the time, many of these coefficients will be zero. FleschReadingEase is the Flesch reading ease computed by Microsoft Word for the student essay;

FleschKincaidGradeLevel is the Flesch-Kincaid reading level computed by Microsoft Word for the student essay;
CosTheta is computed as per the explanation further below;
VarRatio is computed as per the explanation further below;
% SpellingErrors is computed as the number of spelling errors computed by Microsoft Word expressed as a percentage of total words in the student essay;
% GrammaticalErrors is computed as the number of grammatical errors computed by Microsoft Word expressed as a percentage of total sentences in the student essay;
ModelLength is the vector length of the model answer vector derived as per the explanation further below;
StudentLength is the vector length of the model answer vector derived as per the explanation further below;
StudentDotProduct is the vector dot product of the student and model vectors derived as per the explanation further below;
NoStudentConcepts is the number of concepts covered for which words appear in the student essay;
NoModelConcepts is the number of concepts for which words appear in the model essay;
NoSentences is the number of sentences in the student essay;
NoWords is the number of words in the student essay;
NonConceptualisedWordSRatio is the number of words in the student essay that could not be found in the thesaurus, expressed as a ratio of the total number of words in the student essay;
RatioNPNouns is the ratio of nouns in noun phrases in the student essay compared to the model essay;
RatioNPAdjectives is the ratio of adjectives in noun phrases in the student essay compared to the model essay;
RatioNPPrepositions is the ratio of prepositions in noun phrases in the student essay compared to the model essay;
RatioNPConjunctions is the ratio of conjunctions in noun phrases in the student essay compared to the model essay;
RatioVPVerbs is the ratio of verbs in verb clauses in the student essay compared to the model essay;
RatioVPAdverbs is the ratio of adverbs in verb clauses in the student essay compared to the model essay;
RatioVPAuxilliaries is the ratio of auxiliaries in verb clauses in the student essay compared to the model essay;
RatioVPPrepositions is the ratio of prepositions in verb clauses in the student essay compared to the model essay; and
RatioVPConjunctions is the ratio of conjunctions in verb clauses in the student essay compared to the model essay.

Where a coefficient is near zero it may be changed to zero to simplify the equation. Where the coefficient is zero that component of the equation (i.e. the coefficient and the variable to which the coefficient is applied) may be removed from the equation.

To compare the essays to the model essay, they need to be transformed into a structure suitable for comparison. The process of transforming the essays is as follows:
every word in each essay is lexically normalised by looking up the root concept of each word using a thesaurus; and
a conceptual model of the structure of the essay is built.

### Conceptual Model

To build the conceptual model, the essay is segmented in to noun phrases and verb clauses by a technique hereafter described as “chunking” to get the structure of sentences in terms of subject and predicate, as represented by Noun Phrases (NP) and Verb Phrases (VP). Generally the NP nominates the subject of discussion, and the VP the actions being performed on or by the subject. However VPs are notoriously complex to deal with in comparison to NPs, because they typically can have many clusters of a Verb Clause (VC) and a NP together. It is far easier to identify VCs instead of the complex VPs. The basis of the technique used is to represent the meaning of the words making up the NPs and VCs in a sequence of structured slots containing a numerical value representing the thesaurus index number for the root meaning of the word in the slot. A numerical summary of the meaning of the sentences in the document being considered is thus built up.

The exact structure of the NP and VC slots is discussed further below, but to illustrate the concept and to give a practical example, consider the following. A typical sentence would comprise alternating NPs and VCs as follows. A typical first NP slot word and numerical contents would be;

### Det ADJ ADJ N

The small black dog
100 143 97 678
DET is a determiner, ADJ is an adjective and N is a noun.

A typical first VC slot word and numerical contents would be:

### V ADV ADV

walked slowly down
34 987 67
V is a verb.

A typical concluding NP slot word and numerical contents would be:

### DET N

the street
100 234

The numbers in these examples are thesaurus index numbers for the corresponding words. The numbers here are fictitious, for illustration purposes only. A sentence generally consists of groups of alternating NPs and VCs, not necessarily in that order, so a sentence summary would be represented by a group of NP slots and VC slots containing numerical thesaurus indices. A document summary would then consist of a collection of these groups. Note that a sentence does not have to start with a NP, but can start equally well with a VP.

### NP Structure

Martha Kolln (Kolln, M. (1994) Understanding English Grammar, MacMillan, N.Y.) on page 433 states a rule for defining an NP under transformational grammar as follows

NP=(DET)+(ADJ)+N+(PREP PHR)+(S) (1)

and on page 429 a Prep Phr as follows

PREP PHR=PREP+NP

PREP PHR is a preposition phrase and S is a subject.

When considering the slots to be provided for a NP, (1) above can now be rewritten as

NP=DET ADJ N PREP NP S (2)

The basic component of an NP appears to be

NP=DET ADJ N (3)

and some appended structures. It has been found in practice that

NP=DET ADJ ADJ ADJ N (4)

to be a better structure. If we take this as a basic core structure in a NP, the complete NP structure can be built in terms of this core structure by linking multiple occurrences of this core structure by PREPs. It has been found in practice that we should also allow linking by CONJs (conjunctions). So finally we conclude that the basic component should be

NP=CONJ PREP:DET ADJ ADJ ADJ N (5)

where the 2 slots before the colon are the linking slots, and those following the content slots. Practice indicates that we should allow about 40 occurrences of this basic component as the NP slot template should handle many practical NPs encountered in general English text. In fact the current implementation of the program allows for unlimited occurrences of this basic component. Table 1 shows the first 10 rows of this array.

TABLE 1
Noun Phrase Semantic Structure

| | | | | | | |
|---|---|---|---|---|---|---|
| CONJ | PREP | DET | ADJ | ADJ | ADJ | N |

The first core component in the sentence generally will have the CONJ and PREP slots set to blank (in fact the number 0). Any empty slots will likewise be set to 0.

### VC Structure

Kolln (1994) on page 428 states a rule for defining a VP under transformational grammar as follows:

VP=AUX+V+(COMP)+(ADV) (6)

AUX is an auxiliary. COMP is explained as an NP or ADJ, so by removing this from the VP we end up with a VC as follows

VC=AUX+V+ADV (7)

It has been found in practice that if we modify this VC definition by the addition of extra AUXs and ADVs we obtain a more useful structure as

VC=AUX AUX ADV ADV V AUX AUX ADV ADV (8)

VCs can often be introduced with CONJs, and it has been found in practice that we should also allow PREPs in a VC, so a complete VC definition would be

VC=CONJ PREP AUX AUX ADV ADV V AUX AUX ADV ADV (9)

We should allow for 40 occurrences of this basic VC component to handle VCs encountered in practice. In fact the current implementation of the program allows for unlimited occurrences of this basic component. Table 2 shows the first 10 rows of this array.

TABLE 2
Verb Clause Semantic Structure

| | | | | | | | | | | |
|---|---|---|---|---|---|---|---|---|---|---|
| CONJ | PREP | AUX | AUX | ADV | ADV | V | AUX | AUX | ADV | ADV |

Table 2. Verb Clause Semantic Structure

If a sentence happens to start with a VC, then the CONJ slot will be set to blank (in fact the number 0). Any empty slots will likewise be set to 0.

Table 3 shows positions of sentence components to determine phrase type for 3 positions, table 4 shows the phrase type for more positions. In these tables P is PREP.

TABLE 3

| | | | Phrase |
|---|---|---|---|
| POS1 | POS2 | POS3 | Type |
| CONJ | P | DET | NP |
| CONJ | P | ADJ | NP |
| CONJ | P | N | NP |
| CONJ | P | CONJ | NP |
| CONJ | P | AUX | VC |
| CONJ | P | ADV | VC |
| CONJ | P | V | VC |
| CONJ | P | P | VC |
| CONJ | CONJ | DET | NP |
| CONJ | CONJ | ADJ | NP |
| CONJ | CONJ | N | NP |
| CONJ | CONJ | CONJ | NP |
| CONJ | CONJ | AUX | VC |
| CONJ | CONJ | ADV | VC |
| CONJ | CONJ | V | VC |
| CONJ | CONJ | P | VC |
| CONJ | DET | | NP |
| CONJ | ADJ | | NP |
| CONJ | N | | NP |
| CONJ | AUX | | VC |
| CONJ | ADV | | VC |
| CONJ | V | | VC |
| CONJ | | DET | NP |
| CONJ | | ADJ | NP |
| CONJ | | N | NP |
| CONJ | | AUX | VC |
| CONJ | | ADV | VC |
| CONJ | | V | VC |
| P | DET | | NP |
| P | ADJ | | NP |
| P | N | | NP |
| P | AUX | | VC |
| P | ADV | | VC |
| P | V | | VC |
| P | P | DET | NP |
| P | P | ADJ | NP |
| P | P | N | NP |
| P | P | CONJ | NP |
| P | P | AUX | VC |
| P | P | ADV | VC |
| P | P | V | VC |
| P | P | P | VC |
| P | CONJ | DET | NP |
| P | CONJ | ADJ | NP |
| P | CONJ | N | NP |
| P | CONJ | CONJ | NP |
| P | CONJ | AUX | VC |
| P | CONJ | ADV | VC |
| P | CONJ | V | VC |
| P | CONJ | P | VC |
| P | | DET | NP |
| P | | ADJ | NP |
| P | | N | NP |
| P | | AUX | VC |
| P | | ADV | VC |
| P | | V | VC |
| DET | | | NP |
| ADJ | | | NP |
| N | | | NP |
| AUX | | | VC |
| ADV | | | VC |
| V | | | VC |
| | DET | | NP |
| | ADJ | | NP |
| | N | | NP |
| | AUX | | VC |
| | ADV | | VC |
| | V | | VC |

TABLE 4

| | | Slot | | | | | | | | | | |
|---|---|---|---|---|---|---|---|---|---|---|---|---|
| | | 0 | 1 | 2 | 3 | 4 | 5 | 6 | 7 | 8 | 9 | 10 |
| Phrase | NOUN | CONJ | P | DET | ADJ | ADJ | ADJ | N | | | | |
| Type | VERB | CONJ | P | AUX | AUX | ADV | ADV | V | AUX | AUX | ADV | ADV |

FIG. 8 shows the process 300 of analysing a sentence to partition it in to noun phases and verb clauses. The process 300 commences at the beginning of each sentence which has not been typed into a noun phrase or a verb phrase at 302. The positions (POS) within the document of the first three words are obtained at 304. More or less words may be used, but three has been found to be particularly useful.

While there is at least one word left in the sentence, the process continues through to loop stage 318. The three words at each of the three positions are looked up in the Pattern Table (Table 3) to determine if it is a NP or VC at 308. If the pattern is not recognised, it is invalid the analysis moves on to the next sentence or it moves on until it recognises another NP or VC.

It is determined whether the current phrase type is different from the current type allocated to the sentence. If this is the beginning of the sentence then the answer will necessarily be no, if however the phrase type does change then this indicates at 312 that end of the current phrase and the beginning of the new phrase has been reached. The indexing of the words advances as described further below in relation to 316. In the event that this is the first phrase of the sentence or that the type determined in 380 remains the same, then at 314 the current word is added to the current phrase type. Then at 316 the process advances with the second word is moved to the first word position, the third word becomes the second word position and a new word is read into the third word position, if there are any words left in the sentence. The process then loops back up to 306 while there is at least one word left. If there are not any words left then the process ends.

The following shows an example of the implementation of these structures in practice for the following text:
This essay will discuss why it's a good idea for the Government to raise school leaving age to 17.
It will also state why most people in Australia agree with the Government on this particular topic.

| Paragraph 1 | | |
|---|---|---|
| Sentence 1 | | |
| Phrase 1 (Noun) | | |
| Row 1 | | |
| \|This | \|essay | \| |
| \|DET | \|N | \| |
| \|5082 | \|238 | \| |

| | | | |
|---|---|---|---|
| Phrase 2 (Verb) | | | |
| Row 1 | | | |
| \|will | \|discuss | \|why | \| |
| \|AUX | \|V | \|ADV | \| |
| \|2034 | \|238 | \|99 | \| |

| Phrase 3 (Noun) | |
|---|---|
| Row 1 | |
| \|it's | \| |
| \|N | \| |
| \|25 | \| |
| Row 2 | |

| | |
|---|---|
| \|a | \| |
| \|N | \| |
| \|— | \| |
| Row 3 | |

| \|good | \|idea | \| | |
|---|---|---|---|
| \|ADJ | \|N | \| | |
| \|317 | \|317 | \| | |
| Row 4 | | | |
| \|for | \|the | \|Government | \| |
| \|P | \|DET | \|N | \| |
| \|705 | \|507 | \|63 | \| |

| Phrase 4 (Verb) | | |
|---|---|---|
| Row 1 | | |
| \|to | \|raise | \| |
| \|P | \|V | \| |
| \|71 | \|307 | \| |

| | |
|---|---|
| Phrase 5 (Noun) | |
| Row 1 | |
| \|school | \| |
| \|N | \| |
| \|307 | \| |
| Phrase 6 (Verb) | |
| Row 1 | |
| \|leaving | \| |
| \|V | \| |
| \|−1 | \| |
| Phrase 7 (Noun) | |
| Row 1 | |

| | |
|---|---|
| \|age | \| |
| \|N | \| |
| \|553 | \| |
| Row 2 | |

| | | |
|---|---|---|
| \|to | \|17. | \| |
| \|P | \|N | \| |
| \|71 | \|−1 | \| |

| Paragraph 2 | |
|---|---|
| Sentence 1 | |
| Phrase 1 (Noun) | |
| Row 1 | |
| \|It | \| |
| \|N | \| |
| \|25 | \| |
| Row 2 | |

| \|will | \| | |
|---|---|---|
| \|N | \| | |
| \|131 | \| | |
| Phrase 2 (Verb) | | |
| Row 1 | | |
| \|also | \| | |
| \|ADV | \| | |
| \|8 | \| | |
| Phrase 3 (Noun) | | |
| Row 1 | | |
| \|state | \| | |
| \|N | \| | |
| \|438 | \| | |
| Phrase 4 (Verb) | | |
| Row 1 | | |
| \|why | \| | |
| \|ADV | \| | |
| \|99 | \| | |
| Phrase 5 (Noun) | | |
| Row 1 | | |
| \|most | \|people | \| |
| \|DET | \|N | \| |
| \|5042 | \|373 | \| |
| Row 2 | | |

| | | |
|---|---|---|
| \|in | \|Australia | \| |
| \|P | \|N | \| |
| \|70 | \|502 | \| |

| Phrase 6 (Verb) | | | |
|---|---|---|---|
| Row 1 | | | |
| \|agree | \| | | |
| \|V | \| | | |
| \|20 | \| | | |
| Phrase 7 (Noun) | | | |
| Row 1 | | | |
| \|with | \|the | \|Government. | \| |
| \|P | \|DET | \|N | \| |
| \|7142 | \|507 | \|63 | \| |
| Sentence 2 | | | |

| Phrase 1 (Noun) | | | | |
|---|---|---|---|---|
| Row 1 | | | | |
| \|on | \|this | \|particular | \|topic. | \| |
| \|P | \|DET | \|ADJ | \|N | \| |
| \|70 | \|5082 | \|310 | \|455 | \| |

This chunking method produces a computationally efficient numerical representation of the document.

### Determine Measures

Having processed each essay into the required structure the following methods are used to determine the respective measures.

### Vector Representation

To produce the following measures a vector representation of each essay is built:
CosTheta; VarRatio; ModelLength; StudentLength; and StudentDotProduct.

The vector representation of each essay is built as follows. Each possible root concept in the thesaurus is allocated to a dimension in a hyper-dimensional set of axes. A count is made of each word contributing to each root concept, which becomes the length of a vector in the respective dimension of the vector formed in hyper-dimensional space.

Thus counts of each lexically normalised word into root concepts are used for the vector representation.

There is a comprehensive discussion on the construction of an electronic thesaurus and building a vector representation of the content of a document for automatic information retrieval in Salton, G. (1968) Automatic Information Organization and Retrieval, McGraw-Hill, New York.

However the following example is illustrative. Consider the following start of sentence fragments from successive sentences in 3 separate documents:

| Document Number | Document Text |
|---|---|
| (1) | The little boy . . . A small male . . . |
| (2) | A lazy boy . . . A funny girl . . . |
| (3) | The large boy . . . Some minor day . . . |

Suppose a thesaurus exists with the following root words (concept numbers) and words:

| Concept Number | Words |
|---|---|
| 1. | the, a |
| 2. | little, small, minor |
| 3. | boy, male |
| 4. | large |
| 5. | funny |
| 6. | girl |
| 7. | some |
| 8. | day |
| 9. | lazy |

Three dimensional vector representations of the above document fragments on the first 3 concept numbers (1-3) can be constructed by counting the number of times a word in that concept number appears in the document fragments. These vectors are:

| | Vector on first | |
|---|---|---|
| Document No | 3 concepts | Explanation |
| (1) | [2, 2, 2] | [The, a; little, |
| | | small; boy, male] |
| (2) | [2, 0, 1] | [A, a; ; boy] |
| (3) | [1, 1, 1] | [The; minor; boy] |

The graph in FIG. 3 shows these 3 dimensional vectors pictorially.

In general, these ideas are extended to the approximately 812 concepts in the Macquarie Thesaurus, and all words in the documents. This means that the vectors are constructed in approximately 812 dimensions, and the vector theory carries over to these dimensions in exactly the same way—it is of course hard to visualize the vectors in this hyperspace.

From this vector representation of the essay the ModelLength and StudentLength variable are calculated by determining the length of the vector in the normal manner, i.e.

Length=SquareRoot(x*x+y*y+ . . . +z*z),
where the vector is: vector (x, y, . . . , z).

Also the StudentDotProduct variable can be calculated by determining the vector dot product computed between the model and student essay vectors in the normal manner, i.e.

DotProduct=(x1*x2+y1*y2 . . . +z1*z2),
where the vectors are Vector1(x1, y1, . . . , z1) and Vector 2(x2, y2, . . . , z2).

Next the variable CosTheta can be calculated in the normal manner, i.e.

Cos(theta)=DotProduct(v1,v2)/(length(v1)*length(v2)).

If we assume that document 1 is the model answer, then we can see how close semantically documents 2 and 3 are to the model answer by looking at the closeness of their corresponding vectors. The angle between the vectors varies according to how “close” the vectors are. A small angle indicates that the documents contain similar content, whereas a large angle indicates that they do not have much common content. Angle Theta1 is the angle between the model answer vector and the vector for document 2, and angle Theta2 is the angle between the model answer vector and the vector for document 3.

The cosines of Theta1 and Theta2 can be used as measures of this closeness. If documents 2 and 3 were identical to the model answer, their vectors would be identical to the model answer vector, and would be collinear with it, and have a cosine of 1. If on the other hand, they were completely different, and therefore orthogonal to the model answer vector, their cosines would be 0.

Generally in practice, a document's cosine is between these upper and lower limits.

The variable CosTheta used in the scoring algorithm is this cosine computed for the document being scored.

The variable VarRatio is determined from the number of non-zero dimensions in the student answer divided by the number of non-zero dimensions in the model answer.

For example, the number of concepts that are present in the model answer (document 1) above is 3. This can be determined from the number of non-zero counts in the numerical vector representation.

The number of concepts that are present in document 2 above is 2—the second vector index is 0. To compute the VarRatio for this document 2 we divide the non-zero concept count for document 2 by the non-zero concept count in the model answer i.e. VarRatio=2/3=0.67. The corresponding VarRatio for document 3 is 3/3=1.00.

This simple variable provides a remarkably strong predictor of essay scores, and is generally present as one of the components in the scoring algorithm.

To produce the following measures of the conceptual model is used:

### NoStudentConcepts; NoModelConcepts; NonConceptualisedWordSRatio; RatioNPNouns; RatioNPAdjectives; RatioNPPrepositions; RatioNPConjunctions; RatioVPVerbs; RatioVPAdverbs; RatioVPAuxilliaries; RatioVPPrepositions; and RatioVPConjunctions.

These are determined as described above.

The score and calculation of the measures is shown in FIG. 4.

Once the essay is graded feedback can be given where the essay was covering the correct concepts and where it was not. As shown in FIG. 5 a count of each root concept in the graded essay and a count of each root concept expected in the answer is displayed by the height of a bar for each concept.

Further a word in the essay can be selected and similar concepts in the essay will be displayed by highlighting them.

Also by selecting a concept in model answer essay and displaying similar concepts in the marked essay are displayed is by highlighting.

It is also possible to displaying synonyms of a selected root concept as shown in FIG. 6.

### EXAMPLE

A regression equation was developed from about 100 human graded training essays and an ideal or model answer. The document vectors described above are constructed. Values are then computed for many variables from the relationships between the content and vectors of the model answer and the training essays. Once the training has been performed, and the grading algorithm built, each unmarked essay is processed to obtain the values for the independent variables, and the regression equation is then applied. Generally CosTheta and VarRatio are significant predictors in the scoring equation.

In a trial, Year 10 high school students hand wrote essays on paper on the topic of “The School Leaving Age”. Three trained human graders then graded these essays against a marking rubric. The essays, 390 in total, were then transcribed to Microsoft Word document format. The essay with the highest average human score was selected as the model answer. It had a score of 48.5 out of a possible 54, or 90%. In one test of the system, 100 essays were used to build the scoring algorithm. The scoring algorithm was built using the first 100 essays in the trial when ordered in ascending order of the identifier. The prediction equation is was determined to be:

$$Grade = - 22.35 + 11.00 * CosTheta + 15.70 * VarRatio + 7.64 * Characters Per Word + 0.20 * Number of NP Adjectives$$

This produces a grade out of 54. In this example only 4 independent variables are needed for the predictor equation. The remaining 290 essays were then graded by the equation.

The mean score for the human average grade for these 290 essays was 30.34, while the mean grade given by the computer automated grading was 29.45, a difference of 0.89. The correlation between the human and automated grades was 0.79. The mean absolute difference between the two was 3.90, representing an average error rate of 7.23% when scored out of 54 (the maximum possible human score).

The correlations between the three humans amongst themselves were 0.81, 0.78 and 0.81.

The benefits of averaging the scores from the human graders are shown by the fact that the correlation between the automated grading scores and the mean score of the three humans is higher, at 0.79, than the individual correlations at 0.67, 0.75 and 0.75.

Coefficients of the significant predictors, and the intercept, can be positive or negative. For example it would be expected that the coefficient of the CosTheta predictor would be positive, and the coefficient of SpellingErrors would be negative. However because of mathematical quirks in the data, this may not always occur.

Various transformations of the predictor measures could also be used. They could include square roots and logarithms. These are typical transformations that are often useful in linear regression. The fourth root of the number of words in an essay is commonly found to be a useful predictor.

Other examples of equations that have been calculated in test batches of essays include the following.

Grade=31.49+18.92*CosTheta+17.07*VarRatio−0.23*Ease−1.02*Level

for a score out of 54.

Grade=27.0+16.07*CosTheta+19.06*VarRatio−0.21*Ease−0.71*Level

for a score out of 54.

Grade=−19.59+7.16*CosTheta+12.64*VarRatio+0.07*Number of NP Adjectives+1.82*Level

for a score out of 30.

It is noted that the score can easily be scaled to, for example, be expressed as a percentage. As an example where the score is out of 54, the score can be multiplied by 100 and divided by 54 to get a percentage score.

The coefficients for CosTheta and VarRatio are typically between about 10 and 20 for a score out of about 30 to 50. To obtain a percentage score coefficients of about 20 to 40 can be used. While it is possible to device a generic equation, for example:

$$score = 20 + 40 * CosTheta + 40 * VarRatio - 10 * SpellingErrors - 10 * Grammatical Errors$$

better results are obtained by use of the regression analysis to determine the coefficients rather than fixing them as generic values.

A detailed set of flow charts is contained in FIG. 7. A set of pseudo code explaining the flow charts is listed in Appendix 1.

A skilled addressee will realise that modifications and variations may be made to the present invention without departing from the basic inventive concept.

The present invention can be used in applications other than essay grading, such as in the area of document searching, where the “model answer” document is a document containing the search terms. Other applications and the manner of use of the present invention in those other applications will be apparent to those skilled in the art.

The present invention can be used in applications other than essay grading, such as in the area of machine document translation.

Such modifications and variations are intended to fall within the scope of the present invention, the nature of which is to be determined form the foregoing description.

APPENDIX 1
Pseudo Code for Automated Essay Grading System-an
Explanation of the Flow Chart of FIG. 3

1.0 MarkIT

Structure Document (Model Answer) (2.0)
Structure Document (Student Answer) (2.0)
Compute Ratios Between Model Answer and Student Answer (10.2)
Compute Student Mark

2.0 Structure Document (document)

Chunk document into paragraphs (2.1)
For each paragraph in the document (3.0)

Set all concepts hit counts to zero (9.2)
Chunk paragraph into sentences (3.1)
For each sentence in the paragraph (4.0)

Word list = Chunk sentence into words (4.1.1)
Get a list of non-empty from word list (4.1.2)
Tag each non-empty words with its Part of Speech (POS) [third-
party]
Chunk Sentence Into Phrases (4.1.4)

Compute total hit counts for each concept by adding up the concept's hit
count and their related concepts' hit counts (9.3, 8.1)
Contextualise each word (3.2, 4.2, 5.2, 6.2, 7.2)

Compute grammatical statistics (10.1)

4.1.4 Chunk sentence into phrases (word list)

Current phrase type = Untyped
Get the first three words from word list into word1, word2 and word3
While word1 <> null

New phrase type = Look up phrase type (word1's POS, word2's POS,
word2's POS) in table 1, from top to bottom (5.3)
If new phrase type <> current phrase type

Current phrase = new phrase

Add word1 to current phrase (5.1)
Word1 = word2, word2 = word3, word3 = next word from word list

5.1 Add Word into a phrase (word)

Successful = Add word into current phrase row (6.1)
If not succeessful

Current phrase row = new phrase row
New phrase row's current slot = 0
Add word into current phrase row (6.1)

6.1 Add Word into a phrase row (word)

If row type <> INVALID and word's POS <> NO_POS

Search for next POS slot from current slot (inclusive) onwards (table 2)
If end of the row

Return false

Else

Slot word
Current slot = current slot + 1
Set word's concept (7.1)
Return true

Else

Slot word
If word's POS <> NO_POS

Set word's concept (7.1)

Return true

7.1 Set word's concept

Get concept list (word, POS) (9.4)
If concept list = null

Stemmed word = Stem word using Porter Stemmer [third-party]
Get concept list (stemmed word, POS) (9.4)

9.4 Get concept list (word, POS)

Concept list = Look up concepts related to word & POS in the database system
If concept list <> null

For each concept number <= MAX_CONCEPT_NUMBER

Concept[number]'s hit count++

Return concept list

7.2 Set word's most relevant concept

If concept list <> null

Most relevant concept = one of the concepts with the highest total hit
count

1. A method of comparing text based documents comprising:
lexically normalising each word of the text of a first document to form a first normalised representation;
building a vector representation of the first document from the first normalised representation;
lexically normalising each word of the text of a second document to form a second normalised representation;
building a vector representation of the second document from the second normalised representation;
comparing the alignment of the vector representations to produce a score of the similarity of the second document to the first document.

2. A method as claimed in claim 1, wherein the lexical normalisation converts each word in the respective document into a representation of a root concept as defined in a thesaurus.

3. A method as claimed in claim 2, wherein each word is used to look up the root concept of the word in the thesaurus.

4. A method as claimed in claim 2, wherein each root word is allocated a numerical value.

5. A method as claimed claim 1, wherein the normalisation process produces a numeric representation of the document.

6. A method as claimed in claim 2, wherein each normalised root concept forms a dimension of the vector representation.

7. A method as claimed in claim 6, wherein the number of occurrences of each normalised root concept is counted.

8. A method as claimed in claim 7, wherein the count of each normalised root concept forms the length of the vector in the respective dimension of the vector representation.

9. A method as claimed in claim 1, wherein the comparison of the alignment of the vector representations produces the score by determining the cosine of an angle (theta) between the vectors.

10. A method as claimed in claim 9, wherein the cos(theta) is calculated from the dot product of the vectors and the length of the vectors.

11. A method as claimed in claim 2, wherein the number of root concepts in each document is counted.

12. A method as claimed in claim 11, wherein the count of concepts of the second document is compared to the count of concepts of the first document to produce a contribution to the score of the similarity of the second document to the first document.

13. A method as claimed in claim 12, wherein the contribution of each root concept of non-zero count is one.

14. A method as claimed in claim 12, wherein the comparison is a ratio.

15. A method as claimed in claim 1, wherein the first document is a model answer essay, the second document is an essay to be marked and the score is a mark for the second essay.

16. A method as claimed in claim 1, further comprising:
partitioning words of the first document into noun phrases and verb clauses;
partitioning words of the second document into noun phrases and verb clauses;
comparing the partitioning of the first document to the second document to produce a contribution to the score of the similarity of the second document to the first document.

17. A system for comparing text based documents comprising:
means for lexically normalising each word of the text of a first document to form a first normalised representation;
means for building a vector representation of the first document from the first normalised representation;
means for lexically normalising each word of the text of a second document to form a second normalised representation;
means for building a vector representation of the second document from the second normalised representation;
means for lexically normalising the text of a first document;
means for comparing the alignment of the vector representations to produce a score of the similarity of the second document to the first document.

18. A system as claimed in claim 17, further comprising means for looking up a thesaurus to find a root concept from each word in the respective document and for providing said root concept to the respective means for lexically normalising each word in the respective document, wherein said respective means converts each word into a representation of the corresponding root concept.

19. A system as claimed in claim 18, wherein the respective means for building a vector representation forms a dimension of the vector representation from each normalised root concept.

20. A system as claimed in claim 19, wherein the respective means for building a vector representation counts the number of occurrences of each normalised root concept and said count forms the length of the vector in the respective dimension of the vector representation.

21. A system as claimed in claim 17, wherein the means for comparing the alignment of the vector representations produces the score by determining the cosine of an angle (theta) between the vectors.

22. A system as claimed in claim 21, wherein the means for comparing the alignment of the vector representations is configured to calculate the cos(theta) from the dot product of the vectors and the length of the vectors.

23. A system as claimed in claim 20, wherein the respective means for building a vector representation counts the number of non-zero root concepts in the respective document.

24. A system as claimed in claim 23, wherein the means for comparing the alignment of the vector representations compares the count of concepts of the second document to the count of concepts of the first document to produce a contribution to the score of the similarity of the second document to the first document.

25. A method of comparing text based documents comprising:
partitioning words of a first document into noun phrases and verb clauses;
partitioning words of a second document into noun phrases and verb clauses;
comparing the partitioning of the first document to the second document to produce a score of the similarity of the second document to the first document.

26. A method as claimed in claim 25, wherein each word in the document is lexically normalised into root concepts.

27. A method as claimed in claim 25, wherein the comparison of the partitioning of the documents is conducted by determining a ratio of the number of one or more types of noun phrase components in the second document to the number of corresponding types of noun phrase components in the first document and a ratio of the number of one or more types of verb clause components in the second document to the number of corresponding types of verb clause components in the first document, wherein the ratios contribute the score.

28. A method as claimed in claim 27, wherein the types of noun phrase components are: noun phrase nouns, noun phrase adjectives, noun phrase prepositions and noun phrase conjunctions.

29. A method as claimed in claim 27, wherein the types of clause components are: verb clause verbs, verb clause adverbs, verb clause auxiliaries, verb clause prepositions and verb clause conjunctions.

30. A method as claimed in claim 24, wherein the first document is a model answer essay, the second document is an essay to be marked and the score is a mark for the second essay.

31. A system for comparing text based documents comprising:
means for partitioning words of a first document into noun phrases and verb clauses;
means for partitioning words of a second document into noun phrases and verb clauses;
means for comparing the partitioning of the first document to the second document to produce a score of the similarity of the second document to the first document.

32. A method of comparing text based documents comprising:
lexically normalising each word of the text of a first document to form a first normalised representation;
determining the number of root concepts in the first document from the first normalised representation;
lexically normalising each word of the text of a second document to form a second normalised representation;
determining the number of root concepts in the second document from the second normalised representation;
comparing the number of root concepts in the first document to the number of root concepts in the second document to produce a score of the similarity of the second document to the first document.

33. A method as claimed in claim 32, further comprising:
partitioning words of the first document into noun phrases and verb clauses;
partitioning words of the second document into noun phrases and verb clauses;
comparing the partitioning of the first document to the second document to produce a contribution to the score of the similarity of the second document to the first document.

34. A system for comparing text based documents comprising:
means for lexically normalising each word of the text of a first document to form a first normalised representation;
means for determining the number of root concepts in the first document from the first normalised representation;
means for lexically normalising each word of the text of a second document to form a second normalised representation;
means for determining the number of root concepts in the second document from the second normalised representation;
means for comparing the number of root concepts in the first document to the number of root concepts in the second document to produce a score of the similarity of the second document to the first document.

35. A method of grading a text based essay document comprising:
providing a model answer;
providing a plurality of hand marked essays;
providing a plurality of essays to be graded;
providing an equation for grading essays, wherein the equation has a plurality of measures with each measure having a coefficient, the equation producing a score of the essay being calculated by summing each measure as modified by its respective coefficient, each measure being determined by comparing each essay to be graded with the model essay;
determining the coefficients from the hand marked essays;
applying the equation to each essay to be graded to produce a score for each essay.

36. A method according to claim 35, wherein determining the coefficients from the hand marked essays is performed by linear regression.

37. A method according to claim 35, wherein the measures include the scores produced by the method of comparing text based documents as claimed in claim 1.

38. A system for grading a text based essay document comprising:
means for determining coefficients in an equation from a plurality of hand marked essays, wherein the equation is for grading an essay to be marked, the equation comprising a plurality of measures with each measure having one of the coefficients, the equation producing a score for the essay which is calculated by summing each measure as modified by its respective coefficient,
means for determining each measure by comparing each essay to be graded with the model essay;
means for applying the equation to each essay to be graded to produce a score for each essay from the determined coefficients and determined measures.

39. A method of providing visual feedback on an essay grade comprising:
displaying a count of each root concept in the graded essay and a count of each root concepts expected in the answer based on a model essay.

40. A method as claimed in claim 39, wherein each root concept corresponds to a root meaning of a word as defined by a thesaurus.

41. A method as claimed in claim 39, wherein the count of each root concept is determined by lexically normalising each word in the graded essay to produce a representation of the root meanings in the graded essay and counting the occurrences of each root meaning in the graded essay.

42. A method as claimed in claim 41, wherein the count of each root concept is determined by lexically normalising each word in the model essay to produce a representation of the root meanings in the model essay and counting the occurrences of each root meaning in the model essay.

43. A method as claimed in claim 39, further comprising selecting a concept in the graded essay and displaying words belonging to that concept in the graded essay.

44. A method as claimed in claim 43, wherein words related to other concepts in the graded essay are also displayed.

45. A method as claimed in claim 39, further comprising selecting a concept in model essay and displaying words belonging to that concept in the model essay.

46. A method as claimed in claim 45, wherein words related to other concepts in the model essay are also displayed.

47. A method as claimed in claim 39, further comprising displaying synonyms to a selected root concept.

48. A system for providing visual feedback on an essay grading comprising:
means for displaying a count of each root concept in the graded essay and a count of each root concepts expected in the answer.

49. A method of numerically representing a document comprising:
lexically normalising each word of the document;
partitioning the normalised words of the document into parts, which each part designates as one of a noun phrase or a verb clause.

50. A method as claimed in claim 49, wherein a plurality of words are used to determine whether each part is a noun phase or a verb clause.

51. A method as claimed in claim 49, wherein the first three words of each part are used to determine whether the part is a noun phrase or a verb clause.

52. A method as claimed in claim 49, wherein each word in a part is allocated to a column-wise slot of a noun phrase or verb clause table.

53. A method as claimed in claim 52, wherein each slot of the table is allocated to a grammatical type of word.

54. A method as claimed in claim 53, wherein words are allocated sequentially to slots in the appropriate table if they are of the grammatical type of the next slot.

55. A method as claimed in claim 54, wherein in the event that the next word does not belong in the next slot, the slot is left blank and the sequential allocation of slots moves on one position.

56. A method as claimed in claim 55, wherein in the event that the next word does not belong to the table type of the current part then this indicates an end to the current part.

57. A method as claimed in claim 52, wherein the tables have a plurality of rows such that when the next word does not fit into the rest of the row following placement of the current word in the current part, but the word does not indicate an end to the current part then it is placed in the next row of the table.

58. A system for numerically representing a document comprising:
means for lexically normalising each word of the document;
means for partitioning the normalised words of the document into parts, which each part designates as one of a noun phrase or a verb clause.

59. A computer program configured to control a computer to perform the method as claimed in claim 1.

60-71. (canceled)

72. A method of comparing text based documents comprising:
partitioning words of a first document into noun phrases and verb clauses;
partitioning words of a second document into noun phrases and verb clauses;
comparing the partitioning of the first document to the second document to produce a score of the similarity of the second document to the first document.
